(19) United States
(12) Patent Application Publication
(10) Pub. No.: US 2024/0094073 A1
(43) Pub. Date: Mar. 21, 2024

(54) STRAIN GAUGE TRANSDUCER

(71) Applicant: NTL Co., Ltd., Tokyo (JP)

(72) Inventor: Kazuyuki YOKOTA, Tokyo (JP)

(21) Appl. No.: 18/520,809

(22) Filed: Nov. 28, 2023

Related U.S. Application Data
(63) Continuation of application No. PCT/JP22/21166, filed on May 23, 2022.

(30) Foreign Application Priority Data
Jun. 1, 2021 (JP) 2021-092094
Nov. 19, 2021 (JP) 2021-188426

(51) Int. Cl. G01L 1/22

(52) U.S. Cl. CPC G01L 1/2287

(57) ABSTRACT

A strain gauge transducer comprises: a casing comprising a deforming body to be deformed by an external force; a strain gauge disposed on the deforming body; a conductive wire connected to the strain gauge and drawn to outside of the casing through a through hole provided on the casing; a covering member covering the conductive wire with a gap between the covering member and the conductive wire, one end of the covering member being in close contact with the casing; a circuit board connected with the conductive wire; and a cable relay tube housing the circuit board, in close contact with the other end of the covering member. A continuous ventilation passage through the gap from an interior of the casing to an interior of the cable relay tube is formed and contacts the outside air at a surface of the cable relay tube.

### TECHNICAL FIELD

The present invention relates to a strain gauge transducer for measuring a physical quantity such as pressure by converting the physical quantity into an electrical signal through a strain gauge.

### BACKGROUND

Conventionally, there has been known a strain gauge transducer for measuring a physical quantity such as pressure by converting the physical quantity into an electrical signal through a strain gauge.

The strain gauge has a characteristic that the electrical resistivity thereof changes when subjected to a force, and a small change in an output electrical signal due to the change in the resistivity can be amplified and extracted by a bridge circuit or an amplifier. For example, it is possible to measure a pressure applied to a deforming body by attaching a strain gauge to the deforming body that is deformed when subjected to the pressure, and recording a change in the output electric signal.

Strain gauges can be roughly divided into metal (foil) strain gauges and semiconductor strain gauges. Pressure gauges and pore water pressure transducers adopting either of these strain gauges are conventionally manufactured and sold as strain gauge transducers. In addition, strain gauge transducers have been used as equipment for measuring pressure or stress, such as soil pressure transducers, hydraulic pressure gauges, and load gauges.

These pressure gauges and so on are used in model experiments performed in a wide range of fields such as shipbuilding, railways, construction, disaster prevention structures, and natural disasters (tsunami pressure, earthquake shaking, strong wind pressure) in which real structures are reduced, and contribute greatly to technological development necessary for development of social infrastructure and research related to human safety.

Pressure gauges as described above are known, for example, as those described in PTL1.

Pressure gauges used in the medical field are known, for example, as those described in PTL2.

### CITATION LIST

### Patent Literature

[PTL1] JP H4(1992)-346042 A
[PTL2] JP H7(1995)-275211 A

### SUMMARY

Incidentally, among the strain gauge transducers mentioned above, some are designed to be used underwater, and thus the strain gauge and the deforming body thereof are housed in a hermetically sealed casing. In such strain gauge transducers, particularly in a sensitive device capable of detecting a small pressure, there has been a problem that it takes a very long time from installation in a measurement location until a stable state in which measurement can be performed is obtained. Sometimes it takes one day.

This is considered to be because output (electrical resistivity) of the strain gauge is susceptible to environmental changes such as temperature, whereas when the casing is sealed, the environment outside the casing is not quickly reflected inside the casing, and the environment around the strain gauge in the casing changes slowly for a long time.

However, when assuming use in water, it is difficult to adopt a configuration in which an opening is provided in the casing itself to allow direct ventilation to the outside through the opening, since water easily enters from the opening, which can cause circuits to short-circuit. Such problems are particularly significant in the case of using semiconductor strain gauges that are highly accurate and sensitive to changes in force.

In order to cope with such a problem, as described in PTL2, it is conceivable to form an opening in a casing with a strain gauge placed inside, and connect a ventilation hose to the opening so that ventilation can be performed between the inside of the casing and the outside air through the ventilation hose. It is also conceivable to place the ventilation hose inside jacket of a cable for taking out a signal from the strain gauge. However, if the ventilation hose is provided separately from the cable, the structure becomes complicated, which is not preferable in terms of cost and handling. If a ventilation passage is simply provided inside the jacket of the cable, the cable may become thicker and stiffer, resulting in difficulty in handling.

An object of the present invention is to solve such a problem and to realize a strain gauge transducer that can start measurement soon after its installation and is easy to handle, as a strain gauge transducer for measuring a physical quantity such as a pressure by converting the physical quantity into an electric signal using a strain gauge.

### Solution to Problem

In order to achieve the above object, a strain gauge transducer according to the present invention is a strain gauge transducer comprising: a casing comprising a deforming body configured to deform in response to an external force; a strain gauge disposed on the deforming body; a conductive wire connected to the strain gauge and drawn to outside of the casing through a through hole provided on the casing, a covering member covering the conductive wire with a gap between the covering member and the conductive wire, a first end of the covering member being in close contact with the casing; a circuit board, the conductive wire being connected to the circuit board; and a housing configured to house the circuit board, in close contact with a second end of the covering member different from the first end. In the strain gauge transducer, a continuous ventilation passage may be formed through the gap from an interior of the casing to the second end of the covering member. Further, the ventilation passage may be continuous from the interior of the casing to an interior of the housing through the gap, and is in contact with an outside air at a surface of the housing.

It is conceivable that the strain gauge transducer further comprises an insulating coating on a surface of the conductive wire, and that the gap is formed between the insulating coating and the covering member.

It is also conceivable that the through hole passes through an interior of a protrusion formed on an exterior of the casing, and the first end of the covering member is in close contact with the protrusion such that the covering member covers an outer periphery of the protrusion. It is also conceivable that the covering member is waterproof.

It is also conceivable that the ventilation passage contacts the outside air at an opening formed on a surface of the housing, and the housing comprises a water repellent material having water repellency on an outer surface of the housing around the opening.

Alternatively, it is also conceivable that the housing comprises, instead of the above water repellent material, a water repellent material having water repellency and air permeability that covers the opening.

Another strain gauge transducer according to the present invention is a strain gauge transducer comprising: a casing comprising a deforming body configured to deform in response to an external force; a strain gauge disposed on the deforming body; a first conductive wire connected to the strain gauge and drawn to outside of the casing through a through hole provided on the casing, a first covering member covering the first conductive wire with a gap between the first covering member and the first conductive wire, a first end of the first covering member being in close contact with the casing; a second conductive wire configured to provide an output signal to an external device; a circuit connected with the first conductive wire and the second conductive wire; a first ventilation passage passing through the gap and continuous from an interior of the casing to a second end of the first covering member different from the first end; and a second ventilation passage formed along the second conductive wire. In the strain gauge transducer, a continuous ventilation passage including the first ventilation passage and the second ventilation passage may be formed from the interior of the casing, through the second end of the first covering member, to vicinity of one end of the second conductive wire on an opposite side from the circuit. Further, a cross-sectional area of the second ventilation passage may be smaller than a cross-sectional area of the gap.

In addition, the present invention described above can be implemented not only in the manner described above, but also in any other manner, such as a method of measuring a physical quantity such as a pressure using a strain gauge transducer, a system including a strain gauge transducer and a peripheral device thereof, and a component constituting the strain gauge transducer.

According to the present invention as described above, it is possible to realize a strain gauge transducer that can start measurement soon after its installation and is easy to handle, as a strain gauge transducer for measuring a physical quantity such as a pressure by converting the physical quantity into an electric signal using a strain gauge.

### BRIEF DESCRIPTION OF DRAWINGS

FIG. 1 is a perspective view schematically showing a configuration of a pressure gauge according to a first embodiment of the strain gauge transducer of the present invention.

FIG. 2 is a schematic plan view of the pressure gauge shown in FIG. 1.

FIG. 3A and FIG. 3B are schematic cross-sectional views taken along A-A and B-B lines, respectively, illustrating cross-sections of the cables 20 and 40 included in the pressure gauge shown in FIG. 2. FIG. 3C is a schematic cross-sectional view of the cable 20 in a state different from the state of FIG. 3A.

FIG. 4A is a schematic cross-sectional view of the pressure gauge shown in FIG. 2, taken along a C-C line. FIG. 4B is a schematic end view showing a configuration of an end face of the cable relay tube 30 shown in FIG. 4A, as viewed from the arrow D side.

FIG. 5A and FIG. 5B are cross-sectional views corresponding to FIG. 3A, respectively showing cross-sections of cables according to comparative examples.

FIG. 6A and FIG. 6B are views respectively corresponding to FIG. 4A and FIG. 4B, showing a configuration of a pressure gauge according to a second embodiment of the present invention.

FIG. 7A is a schematic cross-sectional view corresponding to FIG. 4A and a part of FIG. 6A, showing a configuration of a pressure gauge according to a third embodiment of the present invention. FIG. 7B is a schematic end view showing a configuration of an end face of the cable relay tube 30 shown in FIG. 7A, as viewed from the arrow E side.

FIG. 8 is a schematic end view corresponding to FIG. 7B, showing a configuration of a modification example of the third embodiment,

FIG. 9 is a schematic cross-sectional view showing a configuration of a pressure gauge according to a fourth embodiment of the present invention, corresponding to FIG. 6A and showing a configuration from vicinity of the cable relay cylinder 30 to the connector 50.

FIG. 10 is a schematic cross-sectional view corresponding to FIG. 3B, showing cross-section of the cable 40 included in the pressure gauge shown in FIG. 9.

FIG. 11A and FIG. 11B are schematic cross-sectional views corresponding to FIG. 10A, respectively showing cross sections of the cable 40 used in modification examples of the fourth embodiment.

FIG. 12 is a cross-sectional view corresponding to FIG. 4A, showing a configuration, only near the casing 10, of a pressure gauge in which a modification example is applied to the first embodiment.

FIG. 13A and FIG. 13B are cross-sectional views corresponding to FIG. 4A, respectively showing configurations of pressure gauges in which further modification examples are respectively applied to the first embodiment.

### DESCRIPTION OF EMBODIMENTS

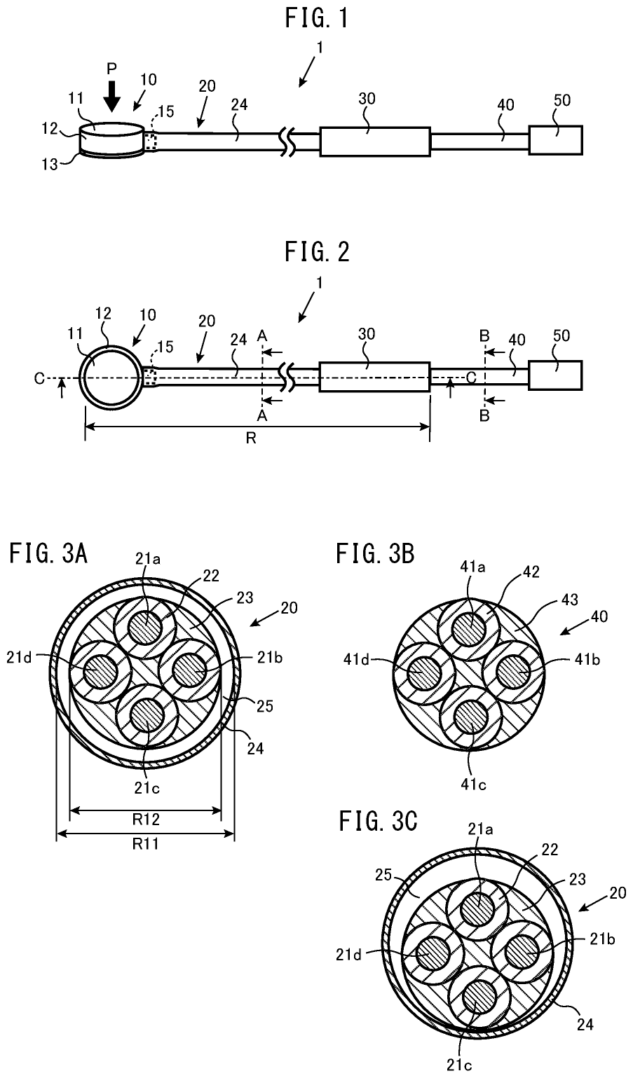

### First Embodiment: FIG. 1 to FIG. 5B

Embodiments of the present invention will be described with reference to the drawings.

First, outline of a configuration of a pressure gauge 1 according to a first embodiment of the strain gauge transducer of the present invention will be described with reference to FIG. 1 and FIG. 2. FIG. 1 is a perspective view schematically showing the configuration of the pressure gauge 1. FIG. 2 is a schematic plan view of the pressure gauge 1.

As illustrated in FIG. 1 and FIG. 2, the pressure gauge 1 has: a casing 10 with a protrusion 15 protruding from a side surface of a substantially cylindrical main body thereof; a cable 20 with a coating; a cable relay tube 30; a cable 40; and a connector 50.

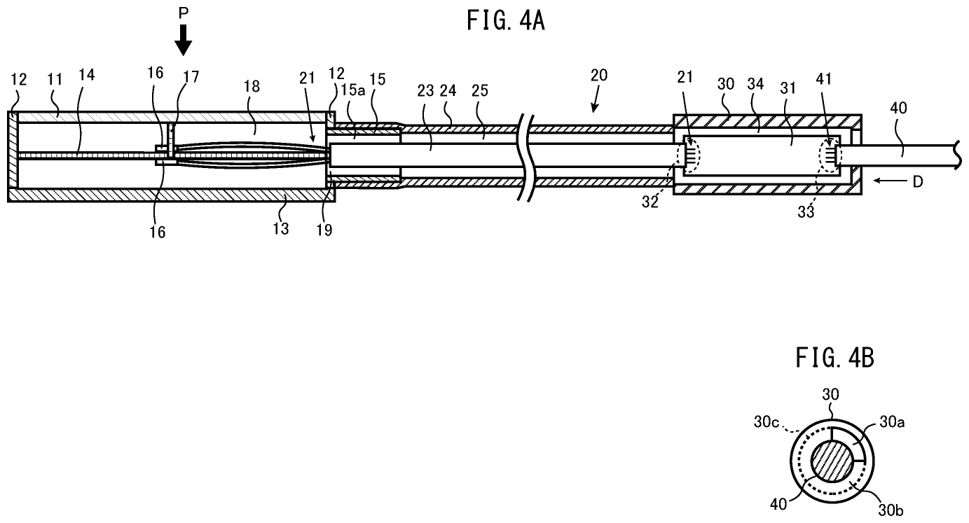

As will be described later with reference to FIG. 4, the casing 10 has a diaphragm 11, a frame 12, a back cover 13, and the protrusion 15, and is a component that incorporates a strain gauge 16 and functions as a sensing unit that detects pressure. The configuration of the casing 10 and the interior thereof may be the same as that of a conventionally used pressure gauge.

The cable 20 is a cable in which a conductor wire for extracting an electric signal output by the strain gauge 16 according to a pressure applied to the casing 10 is coated for insulation and waterproofing.

The cable relay tube 30 is a substantially cylindrical housing configured to house a circuit board 31 (see FIG. 4A) configured to interface with an external control device that controls the pressure gauge 1, and also acquires and records the pressure measured by the pressure gauge 1.

The connector 50 is a connector for connecting the pressure gauge 1 to the external control device, and inputting and outputting signals and data. The cable 40 is a cable for electrically connecting the connector 50 and the circuit board 31 in the cable relay tube 30.

One of the characteristic points in the pressure gauge 1 is structure of the ventilation passage formed through the interior of the cable 20 to allow ventilation inside and outside of the casing 10. This point will be described next referring also to FIG. 3A to FIG. 4B.

First, FIG. 3A shows a cross-section of the cable 20 taken along A-A line in FIG. 2.

As shown in FIG. 3A, the cable 20 has four conductor wires 21a to 21d (hereinafter, the reference numeral “21” is used when not distinguishing between individuals). These conductor wires 21a to 21d functions as two pairs of input lines and output lines for the strain gauge 16 (see FIG. 4A). The conductive wires 21a to 21d are covered with an insulating coating 22 so as not to be short-circuited to other conductive wires. The conductive wires 21a to 21d including the insulating coating 22 may be twisted with one another. In addition, a protective layer 23 made of paper, a metal foil, shield wires, or the like is provided around the insulating coating 22 to bundle four conductive wires and shield them from surrounding magnetism.

As described above, a cable in which conductive wires are bundled with an insulating coating on each of the conductive wires and further shielded is commercially available as a cable for transmitting multiple electrical signals. Incidentally, in FIG. 3A, although the cable 20 is shown such that there is a certain space in the central portion surrounded by the respective insulating coatings 22 covering the four conductive wires 21 and the space is filled with the protective layer 23, this is because the overall configuration is shown schematically for clarity of the drawing. In practice, particularly in the case of a thin cable or a cable in which four conductive wires 21 are twisted together, there is almost no gap in the central portion surrounded by the respective insulating coatings 22. Therefore, even if the protective layer 23 is not provided in the central portion, it is not expected that the central portion has the same function as the gap 25 described below. The same applies to the cross-sections of various cables shown in FIG. 3B and thereafter.

In the cable 20, the covering member 24 is further provided outside the protective layer 23 described above to form a layer shaped gap 25 between the conductive wires 21 and the covering member 24. The covering member 24 is preferably made of a waterproof material such as polyvinyl chloride (PVC), assuming that a portion of the cable 20 is submerged in water. The waterproof property here is sufficient to prevent liquid water from entering the interior at the depth at which the pressure gauge 1 is expected to be used.

Further, it is enough if the gap 25 is sufficient to allow a continuous ventilation passage from the casing 10 with which one end of the cable 20 is in close contact, to the cable relay tube 30 which is connected with the other end of the cable 20, even if the cable 20 is bent or kinked in the middle. From the viewpoint of securing the ventilation passage, it is preferable that the covering member 24 has such a strength that the inner diameter can be substantially maintained without being crushed by water pressure or its own weight.

Such cable 20 can be manufactured by inserting a commercially available input/output power cable into a commercially available PVC tube having an inner diameter larger than the outer diameter of the power cable, and can be realized at low cost.

For example, a PVC tube with an outer diameter of 2.4 mm and a wall thickness of 0.4 mm can be used as the covering member 24, and the cable 20 can be manufactured by inserting into it an input/output power cable with an outer diameter (R12 in FIG. 3A) of about 1.45 mm which is about 0.15 mm smaller than the inner diameter of the covering member 24 (R11 in FIG. 3A). In this configuration, even in consideration of manufacturing error of the covering member 24, about 15 to 20% of the internal space of the covering member 24 is secured as the ventilation passage 25, as viewed in a cross-section perpendicular to the longitudinal direction. This degree of size and the ratio of the ventilation passage 25 allows sufficient ventilation. However, the size, the shape, the material, the ratio of the ventilation passage 25, and the like described here are merely examples and are not essential.

Note that FIG. 3A shows an example in which the gap 25 is formed to have a substantially uniform width around the protective layer 23. However, in practice, as shown in FIG. 3C, the conductive wires 21 including the protective layer 23 is often located at a biased position inside the covering member 24 or partially contacts the covering member 24. Such an arrangement will not cause any problem on the function of the cable 20 at all.

When simply inserting the input/output power cable into the PVC tube as described above, there is no structure for supporting the input/output power cable in the tube. In this case, the positional relation between the input/output power cable (protective layer 23) and the tube (covering member 24) in the cross-section shown in FIG. 3A and FIG. 3C will of course vary due to movement of the cable 20. However, even if such fluctuation occurs, this will not cause any problem on the operation of the pressure gauge 1.

FIG. 3B schematically shows a cross section of the cable 40 taken along the B-B line of FIG. 2.

As shown in FIG. 3B, the cable 40 has four conductive wires 41a to 41d, an insulating coating 42, and a protective layer 43, which are similar to the conductive wires 21a to 21d, the insulating coating 22, and the protective layer 23 of the cable 20, respectively. That is, a commercially available input/output power cable that is inserted into the covering member 24 in the cable 20 can be used as the cable 40.

In the pressure gauge 1, since it is assumed that the portion from the cable relay tube 30 to the connector 50 is not submerged in water, the cable 40 is not waterproof. However, if waterproofing is necessary, waterproofing may be appropriately applied.

Next, FIG. 4A schematically shows a cross section of the pressure gauge 1 taken along the C-C line of FIG. 2.

As shown in FIG. 4A, the casing 10 has a configuration in which the back cover 13 is fitted from the lower side in the drawing with respect to the substantially cylindrical frame 12. The diaphragm 11 is disposed on the upper side of the frame 12 in the drawing. Further, the deforming body 14 is fixed to the inside of the frame 12. The deforming body 14 is a component that, in response to an external force, produces an amount of distortion that is highly linear with respect to the external force received.

There provided a shaft 17 for transmitting a pressure received by the diaphragm 11 to the deforming body 14 near the center of the diaphragm 11, and the deforming body 14 is fixed also to the shaft 17. Strain gauges 16 are provided on both surfaces of the deforming body 14. One strain gauge 16 is provided on each surface of the deforming body 14, and thus two strain gauges 16 in toral are provided in this embodiment, but the number is not limited thereto. A pair of conductive wires 21 are connected to the strain gauge 16 on each surface, for input and output.

Further, on the side surface of the frame 12, the through hole 19 and the hollow protrusion 15 are provided, and the through hole 19, the space 18 inside the casing 10, and the space 15a inside the protrusion 15 form a continuous ventilation passage. The conductive wires 21 are drawn to the outside of the casing 10 through the through hole 19 and the space 15a.

For example, the protrusion 15 can be formed by fixing a pipe made of brass or stainless steel to the inside of the through-hole 19 by bonding, welding, or the like.

Further, the covering member 24 of the cable 20 is fixed to the casing 10 such that one end (left side in the drawing: first end) thereof is fitted and bonded to the outer circumference of the protrusion 15, and the inner surface of the covering member 24 is in close contact with the outer surface of the protrusion 15. Therefore, even if the casing 10 is placed in water, water does not enter the interior of the casing 10 through the space 15a. This close contact or fixing may be realized by means other than bonding.

The conductive wires 21 including the insulating coating 22 and the protective layer 23 are drawn into the space 15a. The protective layer 23 is peeled off near the through hole 19, and among the four conductive wires 21a to 21d, two are drawn out to the upper side and the other two to the lower side of the deforming body 14. Each pair of wires is then connected to the respective strain gauges 16 located on those sides.

Further, the other end (second end) of the covering member 24 of the cable 20 is bonded to one end (left side in the drawing) of the cable relay tube 30 and fixed in close contact with the one end. On the other end side of the covering member 24, the protective layer 23 is peeled off to expose the conductive wires 21a to 21d, and the conductive wires 21a to 21d are connected to the terminals provided on the circuit board 31 in the cable relay tube 30, at the connecting portion 32.

The circuit board 31 is fixed to the cable relay tube 30 by a support member that does not appear in FIG. 4, and a space 34 is secured around the circuit board 31. Further, at the connecting portion 33, the conductive wires 41 of the cable 40 extending toward the connector 50 are connected to the terminal of the circuit provided on the circuit board 31.

FIG. 4B shows an end face of the cable relay tube 30 as viewed from the arrow D side of FIG. 4A.

As shown in FIG. 4B, the cable relay tube 30 has, on the right side surface thereof in FIG. 4A, an opening 30a which is open to the outside even when the cable 40 is connected to the cable relay tube 30. The inside of the broken line 30c corresponds to the space 34 inside the cable relay tube 30, and the opening 30a is provided in a part of the inside of the broken line 30c where the cable 40 does not pass. The remaining portion, that is a support portion 30b, supports the cable 40. The hatched portion in FIG. 4B is the area where the cable 40 is located.

In the pressure gauge 1 having the above-described configuration, when pressure is applied to the diaphragm 11 from the direction indicated by the arrows P in FIG. 1 and FIG. 4A, the diaphragm 11 deforms in accordance with the pressure. A force corresponding to the deformation is transmitted also to the deforming body 14 through the shaft 17, and the deforming body 14 deforms. The resistance value of the strain gauges 16 change in accordance with the deformation of the deforming body 14.

On the other hand, when a predetermined control signal from an external control device is input to the circuit board 31 through the connector 50 and the cable 40, the circuit board 31 provides input signals to the strain gauges 16 through the cable 20. A Wheatstone bridge circuit is formed by the circuit on the circuit board 31, the conductive wires 21, and the strain gauge 16, and the resistance value of the strain gauge 16 can be determined by measuring the voltage or current of the output signal returning from the strain gauge 16 in response to the input signal. In addition, the pressure applied to the diaphragm 11 can be determined by converting the resistance value into the pressure. The circuit on the circuit board 31 can output an output signal indicating the value of the pressure to the external control device through the cable 40 and the connector 50.

Further, in the pressure gauge 1, by fixing one end of the covering member 24 in close contact with the protrusion 15 and the other end in close contact with the cable relay tube 30, a continuous ventilation passage is formed from the space 18 inside the casing 10 to the space 34 inside the cable relay cylinder 30 through the through hole 19 and the gap 25 inside the cable 20. The ventilation passage contacts the outside air at the opening 30a of the cable relay tube 30.

Even when an environmental change, such as a temperature change, other than the pressure occurs around the casing 10, influence of the environmental change that also occurs in the space 18 can be balanced with the outside thorough the ventilation passage in a short time, and the environmental change of the space 18 can be prevented from occurring slowly over a long period of time. Therefore, baseline of the resistance value of the strain gauge 16, and thus also baseline of the measured pressure value can be quickly stabilized.

When this is considered, it is not necessary that the ventilation passage including the gap 25 have sufficient ventilation so that the air in the space 18 and the outside air are quickly exchanged, and it is sufficient that the ventilation passage is a continuous path capable of moving the air to a certain degree.

In the pressure gauge 1, the casing 10 is sealed at locations other than the through hole 19, and the covering member 24 is waterproof and its one end is in close contact with (the protrusion 15 of) the casing 10. Accordingly, even if the casing 10 and the cable 20 are submerged in water, no water can enter the ventilation passage from the outside. It should be noted that if the pressure gauge 1 is not intended to be used in water and, for example, only needs to be dustproof, it is not necessary that the covering member 24 is waterproof. Even in this case, the above-described ventilation passage is sufficiently useful, because it is not preferable to provide an opening that connects the space 18 and the outside directly (at a short distance) on the outer wall of the casing 10, from the viewpoint of preventing dust from entering into the space 18.

Next, some comparative examples of the pressure gauge 1 of the first embodiment described above will be described.

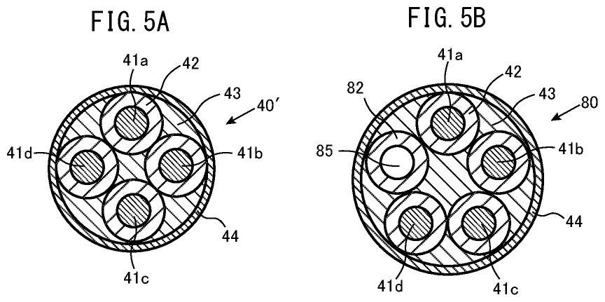

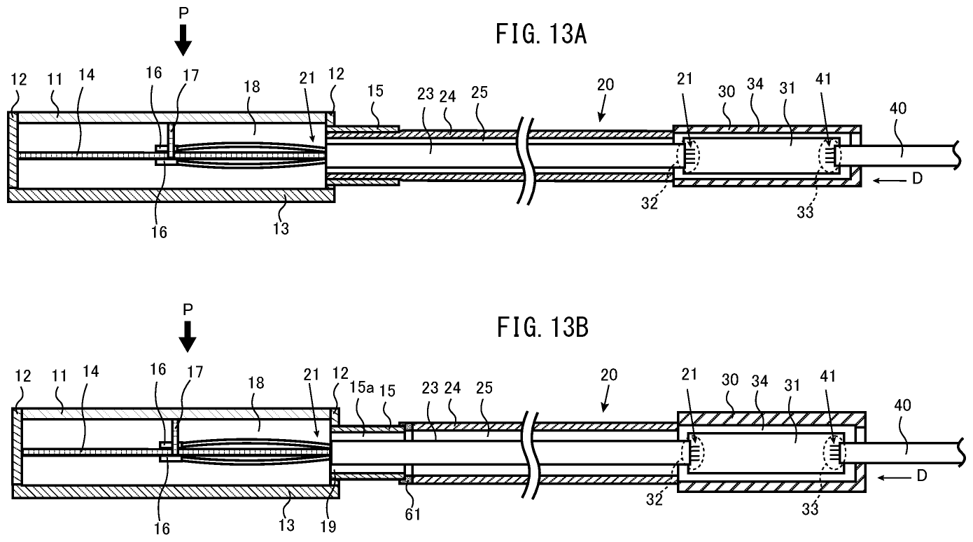

FIG. 5A and FIG. 5B are cross sectional views corresponding to FIG. 3A, showing cross sections of cables provided at positions corresponding to the cable 20 in different comparative examples. Each of these comparative examples is the same as the pressure gauge 1 of the above-described embodiment except for configuration of the cable connecting the casing 10 and the cable relay tube 30. Therefore, the same reference numerals are used. However, since the cables shown in FIG. 5A and FIG. 5B do not have a gap like that of the cable 20, as in the modification example described later with reference to FIG. 13A, the whole cable is drawn into the casing 10 through the space 15a of the protrusion 15.

First, the cable 40′ shown in FIG. 5A has a configuration in which a covering member 44 made of similar material to that of the covering member 24 is provided around the cable 40 shown in FIG. 3B, and no gap is provided inside the covering member 44. In cables used in a general application, gaps are not intentionally provided in order to prevent foreign objects from entering, to strengthen stability of the structure, and the like.

However, in the case of using such a cable 40′, since it is not possible to form a ventilation passage inside the covering member 44, an effect of stabilizing the baseline of the measured pressure value in a short time as in the case of the above-described embodiment cannot be achieved.

Next, the cable 80 shown in FIG. 5B has a configuration in which, as compared with the cable 40′ of FIG. 5A, a hollow spacer 82 is added in the interior of the protective layer 43, thereby providing an air layer 85 inside the covering member 44. With such a cable 80, a ventilation passage can be formed between the space 18 inside the casing 10 and the outside air through the air layer 85. However, if an attempt is made to form a ventilation passage that allows a sufficient amount of ventilation to stabilize the baseline in a short time, the diameter of the protective layer 43 which is the diameter of a substantial conductor bundle increases as compared with the cable 20 shown in FIG. 3A, and accordingly the cable 80 becomes stiffer and more difficult to handle.

In addition, even if the width of the gap 25 in FIG. 3A is taken into account, the diameter of the cable 80 is larger than that of the cable 20. Since it is necessary to pass the entire cable 80 through the space 15a inside the protrusion 15, thicker protrusion 15 is required, which also hinders miniaturization of the casing 10. In addition, the cable shown in FIG. 5B differs from typical configurations and is therefore costly. Considering these points, it can be said that it is possible to configure a pressure gauge 1 with low cost, easy-to-handle, and compact casing 10 by using the cable 20 as shown in FIG. 3A, as compared with the case of using the cable 80 as shown in FIG. 5B.

In general, when the height of the casing 10 of the pressure gauge 1 is smaller than the outer diameter of the cable, it adversely affects the measurement because the cable interferes with the water flow or the like. This is an obstacle to downsizing. However, if the cable 20 made of PVC tubing having an outer diameter of 2.4 mm as described above is used as the covering member 24, it is possible to reduce the size of the casing 10 to the thickness (height) of about 3 mm without problems. The diameter of the casing 10 can also be reduced to about 6 mm.

That is, the configuration in which the ventilation passage as in the above-described embodiment is provided is particularly useful when configuring a small strain gauge transducer. For example, when configuring a strain gauge transducer having the casing 10 with a diameter of 50 mm or less and a thickness of 20 mm or less, the configuration described in the present embodiment is particularly effective. The diameter of the cable or tube may be determined such that the outer diameter of the cable 20 does not exceed the thickness of the casing 10, and a ventilation passage (the gap 25) having a sufficient cross-sectional area may be formed inside the covering member 24.

Further, by providing the ventilation passage by the gap 25, the baseline can be stabilized quickly, so that the baseline can be stabilized in a realistic time without using an expensive strain gauge having high stability. In general, a semiconductor strain gauge with high sensitivity is inferior in stability of the baseline. However, when the above-described configuration using the cable 20 is adopted, even if an inexpensive bulk semiconductor strain gauge is used, the baseline can be stabilized without taking a long time.

In the experiments by the inventor, as an example, the time required for baseline stabilization in a pressure gauge configured using a small housing was reduced to three to four hours by replacing the cable with the cable 20 having the gap 25, under conditions where the baseline stabilization took about seven hours when using the comparative cable 40′ shown in FIG. 5A.

Of course, it is not essential to use a semiconductor strain gauge, and any strain gauge such as a metal foil strain gauge can be used. As described above, according to the pressure gauge 1 of the above-described embodiment, it is considered that multi-point measurement using small pressure gauges that stabilize in a short time can be realized at low cost, and the measurement result can greatly contribute to social infrastructure improvement and safety of human life.

According to the pressure gauge 1 described above, other effects can be achieved. This point will be described below.

First, in the pressure gauge 1, a protrusion 15 is provided on the casing 10, and the covering member 24 is brought into close contact with the protrusion 15 such that the covering member 24 covers the outer periphery of the protrusion 15. Therefore, processing for the close contact is easy, and restrictions on the material, size, and the like of the components are small.

For example, as will be described later with reference to FIG. 13A, even in a configuration in which the covering member 24 is inserted into the space 15a of the projecting portion 15, the covering member 24 and the protrusion 15 can be brought into close contact with each other to form a ventilation passage including the gap 25. However, in consideration of securing the gap 25 without collapse of the covering member 24 inside the space 15a, such a structure imposes restrictions on selection of materials and sizes, and requires more precise machining, leading to increased costs.

Further, in the pressure gauge 1, since both ends of the covering member 24 is fixed in a state that the ends are sufficiently expanded, even when the covering member 24 is flexible, the risk that the ventilation passage is blocked because of collapse of the covering member 24 can be reduced.

The cable 20 is desired to be flexible and deformable, whereas the cable relay cylinder 30 is a member that is normally provided in the pressure gauge 1 and is not expected to deform. By using the cable relay tube 30 as a member for supporting the covering member 24, it is not necessary to provide a dedicated member for supporting the opposite side of the covering member 24 from the casing 10 in the expanded state, and thus it is possible to reduce the number of components and the cost.

Further, even when it is assumed that the casing 10 is submerged and used in water, unless the control device to be connected with the connecter 50 is also used in water, it is usually assumed that the position of the cable relay tube 30 is not submerged in water and placed in air. This is because a long cable 20 allows the casing 10 to be placed at a desired position in water, whereas there is usually no advantage in placing the cable relay tube 30 away from the control device (or the connector 50) at the expense of waterproofing the cable relay tube 30.

Then, it can be said that it is sufficient that the ventilation passage continuing from the space 18 inside the casing 10 continues to the position of the cable relay tube 30. In the pressure gauge 1, since the configuration such that the ventilation passage contacts the outside air at the opening 30a of the cable relay tube 30 is adopted, the cable relay tube 30 can be used also as a member to secure the end of the ventilation passage (the end opposite to the casing 10), and thus the number of components can be reduced also in this respect.

Note that it is not necessary to position the opening 30a on an end face of the cable relay tube 30 toward the connector 50. The opening 30a can be provided on any surface of the cable relay tube.

If it is assumed that the cable relay tube 30 is not submerged in water, it is not essential that the boundary between the covering member 24 and the cable relay tube 30 is waterproofed, and thus this portion may be the end of the ventilation passage.

Further, if the ventilation passage has an outlet in contact with the outside air before the cable 40 as in the cable relay tube 30, it is not necessary to provide a ventilation passage (for example, the gap 25 as in the cable 20) in the cable 40. Therefore, the thickness of the cable 40 can be relatively thin, and there is a wide range of construction and material options. As a result, the cable 40 in the vicinity of the connector 50 to be connected to the external device can be designed for ease of routing.

For example, in a case where a large number of pressure gauges are connected to one control device to perform control of each pressure gauge and processing of detection signals, a large number of cables are wired around the control device. Therefore, there is a large demand for ease of routing. Providing the outlet in contact with the outside air before the cable 40, for example, on the cable relay tube 30, is also useful for meeting such a demand while securing the quick stabilization of the baseline.

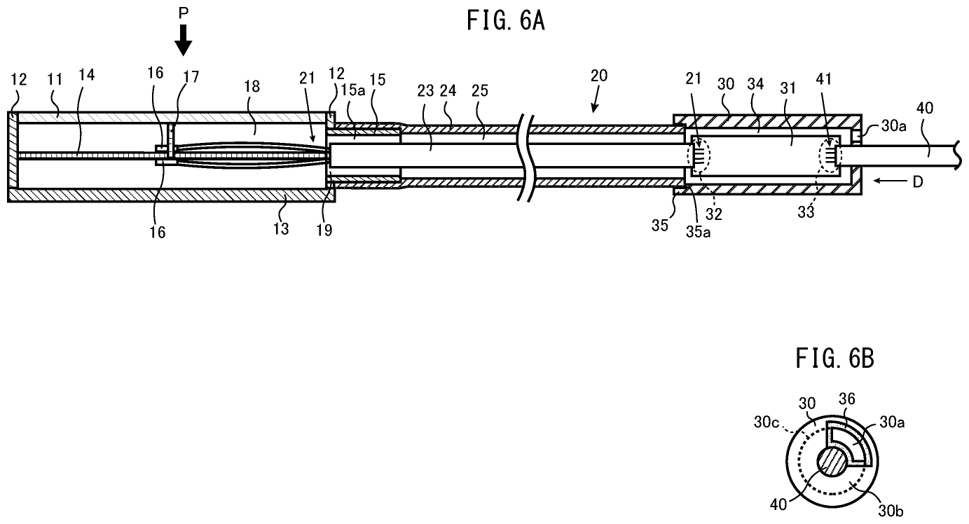

### Second Embodiment: FIG. 6A and FIG. 6B

Next, a pressure gauge 1 which is a second embodiment of the strain gauge transducer of the present invention will be described with reference to FIG. 6A and FIG. 6B. FIG. 6A and FIG. 6B are diagrams respectively corresponding to FIG. 4A and FIG. 4B, showing a configuration of the pressure gauge 1 according to the second embodiment.

The second embodiment is different from the first embodiment in the connection structure between the covering member 24 and the cable relay tube 30, and further different in that a water repellent material is provided around the opening 30a of the cable relay tube 30. Therefore, the description will focus on these points, and the description of other parts will be omitted. The same reference numerals are used for portions corresponding to those of the first embodiment. The above two points can be independently applied as a modification to the first embodiment.

First, in the pressure gauge 1 according to the second embodiment, as shown in FIG. 6A, a thin-walled portion 35 in which the inner diameter of the cable relay cylinder 30 is larger than the other part thereof is formed at the end of the cable relay cylinder 30 on the cable 20 side. The other end (second end) of the covering member 24 is bonded to the inner circumferential surface of the thin-walled portion 35 and a stepped portion 35a at the end of thin-walled portion 35. This configuration ensures a sufficient bonding area between the covering member 24 and the cable relay tube 30, and improves the strength and waterproofing.

Further, a water repellent layer 36 is formed around the opening 30a by a water repellent material having water repellency. The water repellent layer 36 can be formed by any method such as bonding a thin layer or a thin plate made of a water repellent material, applying a water repellent material, or the like. The degree of water repellency may be set in accordance with the required water-resistant performance.

By providing the water repellent layer 36, even when the pressure gauge 1 is used near water and the cable relay tube 30 may be splashed by water, water droplets adhering to the outer surface of the cable relay tube 30 can be prevented from entering the interior through the opening 30a. This is because water droplets flowing along the outer surface of the cable relay tube 30 can be repelled by the water repellent layer 36 so as not to reach the opening 30a. That is, the water repellent layer 36 can reduce the risk of water entering the interior of the cable relay tube 30 even when the opening 30a is provided as the outlet of the ventilation passage, thereby enhancing the waterproofing of the pressure gauge 1.

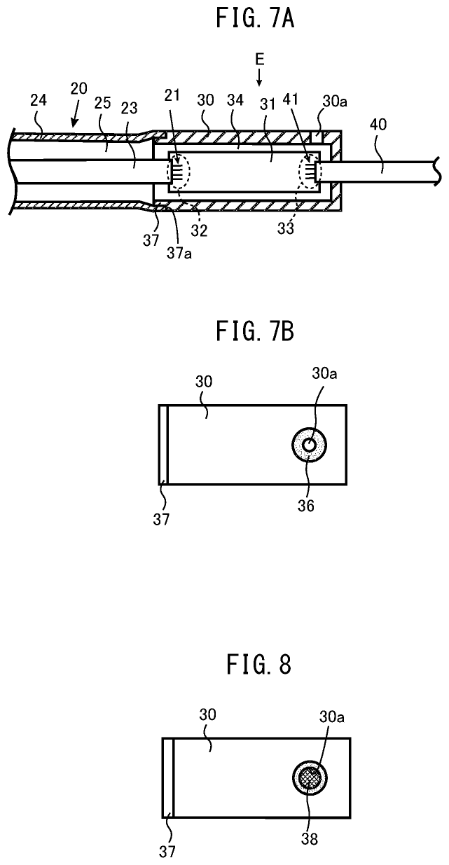

### Third Embodiment: FIG. 7A to FIG. 8

Next, a pressure gauge 1 which is a third embodiment of the strain gauge transducer of the present invention and some modifications thereof will be described with reference to FIG. 7A to FIG. 8.

The third embodiment is different from the second embodiment in the position where the opening 30a and the water repellent material are provided in the cable relay tube 30, and the connection structure between the covering member 24 and the cable relay tube 30. Therefore, the description will focus on these points, and the description of other parts will be omitted. The same reference numerals are used for portions corresponding to those of the second embodiment. The above two points can be independently applied as a modification to the first embodiment and the second embodiment.

FIG. 7A is a schematic cross-sectional view corresponding to FIG. 4 and a part of FIG. 6, showing a configuration of the pressure gauge 1 according to the third embodiment only in a part in the vicinity of the cable relay tube 30. FIG. 7B is a schematic end view showing a configuration of the end face of the cable relay tube 30 shown in FIG. 7A, as viewed from the arrow E.

As shown in FIG. 7A, in the pressure gauge 1 of the third embodiment, the opening 30a is provided in the vicinity of the end, closer to the cable 40, of the side surface of the cable relay tube 30. The cross-sectional profile of the opening 30a is circular as shown in FIG. 7B. The water repellent layer 36 made of a water repellent material is provided around the opening 30a similarly to the second embodiment.

The opening 30a is shown enlarged in FIG. 7B for the sake of clarity, but in practice, a smaller opening can provide sufficient ventilation. This is also the case for FIG. 8 described later.

Even when the opening 30a and the water repellent layer 36 are provided at positions and shapes as shown in FIG. 7A and FIG. 7B, the effects of forming the ventilation passage and improving the waterproofing can be achieved as in case of the second embodiment.

It is preferable that the cross section of the opening 30a has a highly symmetrical shape such as a circular shape or a regular polygonal shape close thereto, because the water repellent layer 36 corresponding to the shape is highly effective in preventing water droplets from entering the opening 30a. Further, when it is assumed that the casing 10 is placed in water, since the cable 20 side comes to a position close to water, it is preferable to provide the opening 30a on the side close to the cable 40 rather than the cable 20 side from the viewpoint of waterproofing. However, the position where the opening 30a is provided and the shapes of the opening 30a are not limited thereto.

Further, as shown in FIG. 7A, in the pressure gauge 1 according to the third embodiment, a thin-walled portion 37 in which the outer diameter of the cable relay cylinder 30 is smaller than the other part thereof is formed at the end of the cable relay cylinder 30 on the cable 20 side. The other end (second end) of the covering member 24 is bonded to the outer circumferential surface of the thin-walled portion 37 and a stepped portion 37a at the end of thin-walled portion 37. Also this configuration ensures, as in the case of the thin-walled portion 35 of the second embodiment, a sufficient bonding area between the covering member 24 and the cable relay tube 30, and improves the strength and waterproofing.

Next, a modification example of the above-described third embodiment will be described. This modification example is different from the third embodiment in that the configuration and arrangement of the water-repellent material are as shown in FIG. 8.

FIG. 8 shows an example in which a water repellent material 38 having air permeability due to a mesh-like portion overlapping with the opening 30a is provided so as to cover the opening 30a. Since no air permeability is required in the surrounding portion of the opening 30a, this portion need not be meshed.

When such a water repellent material is provided, it is possible to prevent water droplets that directly fly to the opening 30a or water droplets that could not be prevented by the surrounding water repellent material from entering the opening 30a, and it is possible to further improve the waterproofing as compared with the configuration shown in FIG. 7B.

It should be noted that the air permeability of the water repellent material 38 may be such that the air permeability between the ventilation passage and the outside air can be ensured to a degree sufficient for the stabilization of the baseline in a short time. It is not necessary to have an opening that is visible to the naked eye like a mesh. Further, the water repellent material covering the opening 30a may be provided inside of the opening 30a or on the inner peripheral surface of the cable relay tube 30, instead of on the outer peripheral surface of the cable relay tube 30.

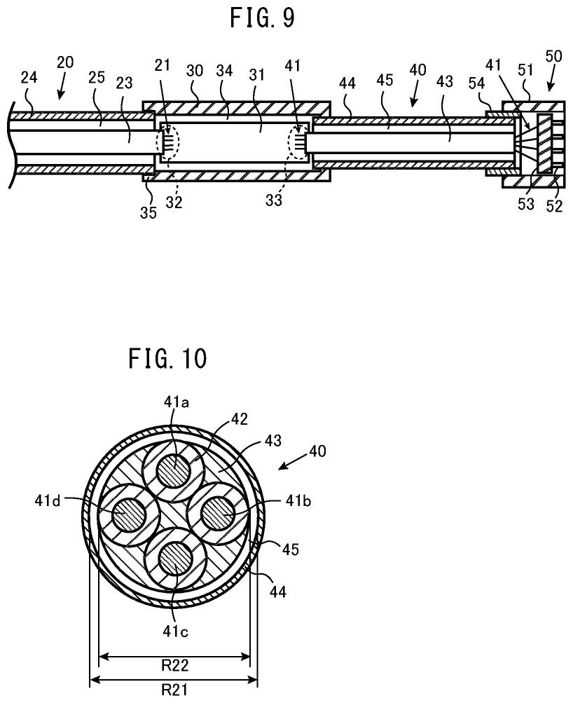

### Fourth Embodiment: FIG. 9 to FIG. 11B

Next, a pressure gauge 1 which is a fourth embodiment of the strain gauge transducer of the present invention and some modifications thereof will be described with reference to FIG. 9 to FIG. 11B.

The fourth embodiment is different from the second embodiment in that an opening 30a is not provided in the cable relay tube 30, and a ventilation passage is provided from the space 18 inside the casing 10 to the vicinity of the end of the cable 40 on the connector 50 side. Therefore, only these points will be described, and the description of other parts will be omitted. The same reference numerals are used for portions corresponding to those of the second embodiment.

FIG. 9 is a schematic cross-sectional view corresponding to FIG. 6A, showing a configuration of the pressure gauge 1 according to the fourth embodiment. FIG. 9 shows a portion from the vicinity of the cable-relay tube 30 to the connector 50 which does not appear in FIG. 6A. FIG. 10 is a schematic cross-sectional view corresponding to FIG. 3B, showing a cross-section of the cable 40 included in the pressure gauge shown in FIG. 9.

As shown in FIG. 9, in the pressure gauge 1 according to the fourth embodiment, the opening 30a is not provided in the cable relay tube 30, and the cable relay tube 30 is sealed. The connecting portions between the cable relay tube 30 and the cables 20 and 40 are also sealed respectively by bonding or the like so that at least water droplets do not enter the inside.

Further, as shown in FIG. 10, as the cable 40, a cable with a covering member 44 as in the case of the cable 20 and a layer shaped gap 45 between the conductive wire 41 and the covering member 44 along the conductive wire 41. However, the difference between the inner diameter of the covering member 44 (R21 in FIG. 10) and the outer diameter of the protective layer 43 (R22 in FIG. 10) in the cable 40 is smaller than the difference between the inner diameter of the covering member 24 (R11 in FIG. 3A) and the outer diameter of the protective layer 23 (R12 in FIG. 3A) in the cable 20. Therefore, the cross-sectional area of the ventilation passage (second ventilation passage) formed in the gap 45 in the cross section perpendicular to the cable longitudinal direction is smaller than the corresponding cross-sectional area of the ventilation passage formed in the gap 25.

As shown in FIG. 9, the connector 50 includes an exterior 51, connector pins 52, and a support member 53. The connector pins 52 are pins for connecting with an interface of an external device. The support member 53 is a member for supporting the pins 52 and includes terminals for connecting the conductor wires 41 to the connector pins 52.

The cable 40 is fixed to the connector 50 by attaching a tubular protective member 54 to the end portion thereof on the side to be connected to the connector 50 and inserting the protective member 54 into the connector 50. Each conductor wire 41 of the cable 40 is connected to a terminal on the support member 53.

At this time, the gap 45 in the cable 40 is opened inside the exterior 51. Since a gap is provided between the exterior 51 and the support member 53, ventilation between the gap 45 and the outside air can be performed through the gap. Even in a state where the connector 50 is connected to the external device, the exterior 51 and the external device do not normally come into close contact with each other, so that similar ventilation can be performed.

With the above configuration, a continuous ventilation passage is formed in the pressure gauge 1. The continuous ventilation passage includes: a first ventilation passage formed by the space 18 inside the casing 10, the through hole 19, and the gap 25 inside the cable 20; and a second ventilation passage formed by the space 34 inside the cable relay tube 30, and the gap 45 inside the cable 40. The continuous ventilation passage continues to the connector 50, and contacts the outside air at the connector 50 only.

By this ventilation passage, as in the case of the first to third embodiments, the influence of the environmental change occurring in the space 18 inside the casing 10 can be balanced with the outside in a short time, and the baseline can be quickly stabilized.

Further, in the configuration according to the fourth embodiment, since the cable relay tube 30 can be sealed, the waterproof property of the cable relay tube 30 can be extremely high.

Incidentally, almost the same effect can be obtained even if the second ventilation passage by the gap 45 is not continuous to the inside of the connector 50, but the covering member 44 is made long enough to reach just before the connector 50, and the second ventilation passage continues only to the vicinity of the end of the conductor wire 41 on the connector 50 side (end opposite from the circuit board 31) and contacts the outside air at this position. However, the configuration in which the covering member 44 is fixed to the connector 50 as shown in FIG. 9 is preferable from the viewpoint of the robustness of the structure.

Here, if a ventilation passage having a certain cross-sectional area can be secured in the cable 20 in contact with the casing 10, it is possible to balance the influence of the environmental changes other than the pressure, such as a temperature change in the space 18 inside the casing 10, between the space 18 and the air in the ventilation passage having much larger volume than the space 18, and thereby reducing the influence. The balance should eventually also be taken up between the outside air, but the effect on the baseline of the measurement by the pressure gauge 1 is not so great, even if ventilation between the ventilation passage in the cable 20 and the outside air and the equilibration thorough the ventilation are slow.

Therefore, even if the cross-sectional area of the ventilation passage provided in the cable 40 is small, the effect of quickly stabilizing the baseline can be achieved to a considerable extent, and thus such a configuration is adopted in the fourth embodiment. As a result, the thickness of the cable 40 extending to the connector 50 can be suppressed, and thus both the high waterproofness and ease of routing in the vicinity of the connector 50 can be achieved.

Thickness of the cable 40 in the fourth embodiment is slightly thicker than in the case of the first to third embodiments. However, in the case where high waterproofness is important in the portion up to the vicinity of the connector 50 including the cable relay tube 30 as well as the portion of the casing 10 and the cable 20, the configuration according to the fourth embodiment is also sufficiently meaningful.

Incidentally, if it is sufficient to facilitate the routing of the cable only in the vicinity of the connector 50, it is conceivable to change the cross-sectional area of the ventilation passage at a position other than the cable relay tube 30 to narrow the ventilation passage only in the vicinity of the connector 50 to narrow the entire cable in the vicinity of the connector 50. However, a cable having a different cross-sectional shape depending on the position in the longitudinal direction is difficult to manufacture and difficult to cope with a change in length. Therefore, it is preferable to adopt a configuration in which different cables are used before and after the cable relay tube 30 where the cable is once interrupted, as shown in FIG. 9.

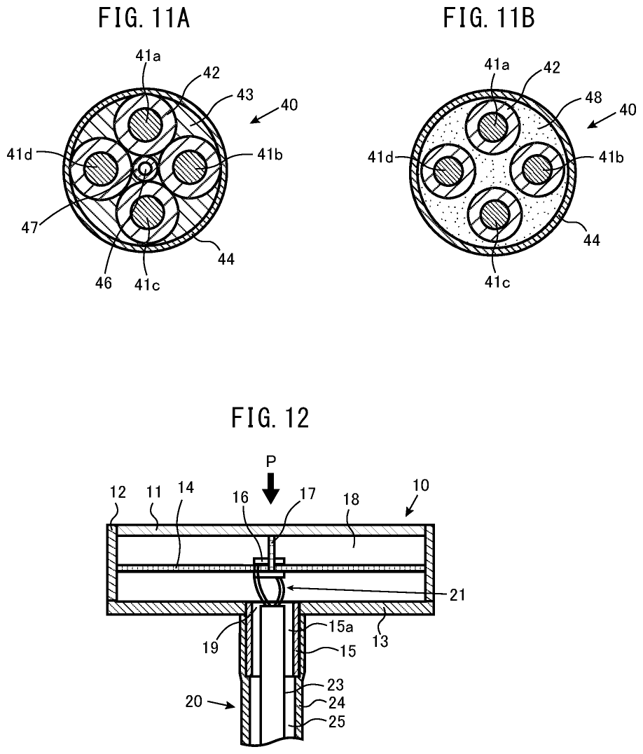

Next, a modification example of the above-described fourth embodiment will be described. This modification example is different from the fourth embodiment in the configuration of the cable 40. FIG. 11A and FIG. 11B respectively show cross-sections of cables 40 that can be used in place of the one shown in FIG. 10.

FIG. 11A shows an example in which a hollow spacer 47 is added inside the protective layer 43, whereby an air layer 46 is provided inside the covering member 44. When using this cable 40, one end of the air layer 46 on the cable relay tube 30 side is exposed to the space 34 inside the cable relay tube 30, and the other end thereof on the connector 50 side is exposed to the outside air, thereby forming a ventilation passage from the space 34 to the vicinity of the connector 50 through the air layer 46.

Since the cross-sectional area of the ventilation passage in the cable 40 may be small as described above, the ventilation passage of the degree required in the cable 40 can be formed without largely increasing the thickness and hardness of the cable 40 even using the spacer 47, unlike the comparative example described with reference to FIG. 5B. It should be noted that the spacer 47 and the air layer 46 are not necessarily provided inside the covering member 44, and may be provided outside the covering member 44.

FIG. 11B shows an example in which conductor wires 41a to 41d are loosely disposed inside the covering member 44, so that a slight gap is formed around the conductor wires. In the cable 40 shown in FIG. 11B, a protective layer 48 made of, for example, a fibrous material is formed around the insulating coating 42, which is not densely filled and has certain gaps.

When using the cable 40 as shown in FIG. 11B, one end of the protective layer 48 on the cable relay tube 30 side is exposed to the space 34 inside the cable relay tube 30, and the other end thereof on the connector 50 side is exposed to the outside air, thereby forming a ventilation passage from the space 34 to the vicinity of the connector 50 through the gaps in the protective layer 48.

It is conceivable to form a ventilation passage having a minimum required degree of ventilation in the cable 40 through this degree of gaps.

### Modification Examples: FIG. 12 to FIG. 13B

Next, other modification examples applicable to each of the above-described embodiments will be described. Here, examples in which the modifications are mainly applied to the first embodiment will be described, but the same modifications can be applied to the other embodiments.

First, in each of the embodiments described above, the protrusion 15 and the through hole 19 are provided on the side surface of the frame 12, but the protrusion 15 and the through hole 19 may be provided in other portions of the casing 10.

FIG. 12 is a cross-sectional view corresponding to FIG. 4A, showing a configuration of the pressure gauge 1 wherein the protrusion 15 and the through hole 19 are provided in the vicinity of the center of the back cover 13 of the pressure gauge 1 according to the first embodiment. In FIG. 12, the cable 20 is shown only in the vicinity of the casing 10, but the configuration of a part not shown in FIG. 12, such as the cable relay tube 30 and the connector 50, is the same as those shown in FIG. 4A.

Even when the projecting portion 15 and the through hole 19 are provided in a portion of the casing 10 other than the side surface of the frame body 12 as described in FIG. 12, the ventilation passage continuing from the space 18 inside the casing 10, through the through hole 19 and the gap 25 inside the cable 20, to the space 34 inside the cable relay tube 30, or further to the vicinity of the connector 50 can be formed in the same manner as in the case of FIG. 4A and the like. Therefore, the baseline can also be stabilized in a short time.

In addition, regarding the close contact portion between the covering member 24 and the protrusion 15 (the casing 10), the structure shown in FIG. 4A is not essential.

For example, as shown in FIG. 13A, it is conceivable that the entire cable 20 including the covering member 24 is drawn into the casing 10 through the inside of the protrusion 15. Even in this case, the covering member 24 and the projecting portion 15 are brought into close contact with each other by bonding or the like so that water, dust, or the like does not enter from a gap therebetween.

Alternatively, as shown in FIG. 13B, an adapter 61 may be provided at an end portion of the covering member 24, and the adapter and the protrusion 15 may be coupled to each other. In this case, not only the covering member 24 but also the adapter 61 functions as a covering member covering the conductive wires 21. Close contact between the adapter 61 and the protrusion 15 may be secured by a conventional means as appropriate.

Furthermore, it is not essential to provide the protrusion 15, and it is also conceivable to directly bond or connect the covering member 24 or the adapter 61 to the outer side wall of the casing 10 to bring the covering member and the casing into close contact with each other.

Even in these configurations, a sufficient ventilation passage can be formed through the gap 25 provided between the covering member 24 and the conductive wires 21 (and the insulating covering material 22 and the protective layer 23 on the outside thereof). However, in view of the number of components, ease of manufacturing, and the like, it can be said that the configuration shown in FIG. 4A is better than the configurations shown in FIG. 13A and FIG. 13B.

Further, in the above embodiments, an example in which the strain gauge transducer is configured as a pressure gauge has been described, but the present invention is not limited thereto. The present invention is generally applicable to devices having a function of measuring a physical quantity such as a given pressure, including devices referred to as names corresponding to measurement targets, such as a soil pressure transducer, a hydraulic pressure gauge, a load gauge, and a pore water pressure transducer.

Although the description of the embodiment has been completed above, in the present invention, the specific shape, material, size, and the like of the entire strain gauge transducer or components thereof, and the measurement method using the strain gauge transducer are not limited to those described in the embodiments.

Further, the features of the above-described embodiments and modifications can be used in combination to the extent that they do not contradict each other. It is also possible to retrieve and implement only some features.

### REFERENCE SIGNS LIST

1 . . . pressure gauge, 10 . . . casing, 11 . . . diaphragm, 12 . . . frame, 13 . . . back cover, 14 . . . deforming body, 15 . . . protrusion, 15a . . . space, 16 . . . strain gauge, 17 . . . shaft, 18 . . . space, 19 . . . through hole, 20, 40, 40′ . . . cable, 21a to 21d, 41a to 41d . . . conductive wire, 22, 42 . . . insulating coating, 23, 43, 48 . . . protective layer, 24, 44 . . . covering member, 25 . . . gap, 30 . . . cable relay tube, 30a . . . opening, 30b . . . support portion, 31 . . . circuit board, 32, 33 . . . connecting portion, 34 . . . space, 35, 37 . . . thin-walled portion, 35a, 37a . . . stepped portion, 36 . . . water repellent layer, 46, 85 . . . air layer, 47, 82 . . . spacer, 50 . . . connector

1. A strain gauge transducer comprising:
a casing comprising a deforming body configured to deform in response to an external force;
a strain gauge disposed on the deforming body;
a conductive wire connected to the strain gauge and drawn to outside of the casing through a through hole provided on the casing,
a covering member covering the conductive wire with a gap between the covering member and the conductive wire, a first end of the covering member being in close contact with the casing;
a circuit board, the conductive wire being connected to the circuit board; and
a housing configured to house the circuit board, in close contact with a second end of the covering member different from the first end,
wherein a continuous ventilation passage is formed through the gap from an interior of the casing to the second end of the covering member, and
the ventilation passage is continuous from the interior of the casing to an interior of the housing through the gap, and is in contact with an outside air at a surface of the housing.

2. The strain gauge transducer according to claim 1, comprising
an insulating coating on a surface of the conductive wire,
wherein the gap is formed between the insulating coating and the covering member.

3. The strain gauge transducer according to claim 1,
wherein the through hole passes through an interior of a protrusion formed on an exterior of the casing, and
the first end of the covering member is in close contact with the protrusion such that the covering member covers an outer periphery of the protrusion.

4. The strain gauge transducer according to claim 1,
wherein the covering member is waterproof.

5. The strain gauge transducer according to claim 1,
wherein the ventilation passage contacts the outside air at an opening formed on a surface of the housing, and
the housing comprises a water repellent material having water repellency on an outer surface of the housing around the opening.

6. The strain gauge transducer according to claim 1,
wherein the ventilation passage contacts the outside air at an opening formed on a surface of the housing, and
the housing comprises a water repellent material having water repellency and air permeability, the water repellent material covering the opening.

7. A strain gauge transducer comprising:
a casing comprising a deforming body configured to deform in response to an external force;
a strain gauge disposed on the deforming body;
a first conductive wire connected to the strain gauge and drawn to outside of the casing through a through hole provided on the casing,
a first covering member covering the first conductive wire with a gap between the first covering member and the first conductive wire, a first end of the first covering member being in close contact with the casing;
a second conductive wire configured to provide an output signal to an external device;
a circuit connected with the first conductive wire and the second conductive wire;
a first ventilation passage passing through the gap and continuous from an interior of the casing to a second end of the first covering member different from the first end; and
a second ventilation passage formed along the second conductive wire,
wherein a continuous ventilation passage including the first ventilation passage and the second ventilation passage is formed from the interior of the casing, through the second end of the first covering member, to vicinity of one end of the second conductive wire on an opposite side from the circuit, and
a cross-sectional area of the second ventilation passage is smaller than a cross-sectional area of the gap.
